(19) United States
(12) Patent Application Publication
(10) Pub. No.: US 2025/0196540 A1
(43) Pub. Date: Jun. 19, 2025

(54) TIRE

(71) Applicant: THE YOKOHAMA RUBBER CO., LTD., Kanagawa (JP)

(72) Inventors: Kensuke HOSHO, Kanagawa (JP); Yuta UCHIDA, Kanagawa (JP)

(21) Appl. No.: 18/835,146

(22) PCT Filed: Oct. 12, 2022
(86) PCT No.: PCT/JP2022/037949

§ 371 Date: Aug. 1, 2024

(30) Foreign Application Priority Data
Aug. 2, 2022 (JP) 2022-017833

(51) Int. Cl. B60C 11/03; B60C 11/13

(52) U.S. Cl. CPC B60C 11/0306; B60C 11/0304; B60C 11/1392; B60C 2011/0339

(57) ABSTRACT

A tire includes main grooves and rows of lands. At least one of the main grooves has a groove wall angle on a vehicle inner side smaller than a groove wall angle on a vehicle outer side. The rows of lands include center, intermediate, and shoulder lands. Shoulder lug grooves in at least one of the shoulder lands communicate with the main groove. The intermediate lands include intermediate lug grooves opening to the main groove and terminating within the intermediate lands, first sipes opening to the main groove and to the intermediate lug grooves, and second sipes opening to the main groove located opposite to the main groove to which the intermediate lug grooves open and opening to the intermediate lug grooves. The first and second sipes each include a chamfer on only one of a step-in side edge or a kick-out side edge.

### TECHNICAL FIELD

The present technology relates to a tire including a plurality of rows of land portions defined by a plurality of main grooves in a tread portion and particularly relates to a tire that can provide improved dry performance, wet performance, and snow performance to a high degree and in a compatible manner.

### BACKGROUND ART

Some pneumatic tires have a tread pattern in which a plurality of main grooves extending in a tire circumferential direction are formed in a tread portion and a plurality of lug grooves and sipes that extend in a tire width direction are formed in respective land portions defined by the main grooves (for example, see International Patent Publication No. WO 2016/024593).

For such a pneumatic tire, maintaining good dry performance while exhibiting excellent wet performance and snow performance based on groove components including main grooves, lug grooves, and sipes is awaited. For, in particular, all-season tires, providing dry performance, wet performance, and snow performance to a high degree and in a compatible manner is awaited. However, since dry performance is contradictory to wet performance and snow performance, providing these performances to a high degree and in a compatible manner is difficult. For that reason, further improvement is desired to satisfy performance required from the market.

### SUMMARY

The present technology provides a tire that can provide improved dry performance, wet performance, and snow performance to a high degree and in a compatible manner.

A tire according to an embodiment of the present technology includes, in a tread portion, a plurality of main grooves extending in a tire circumferential direction and a plurality of rows of land portions defined by the plurality of main grooves and having a specified mounting direction to a vehicle.

At least one main groove of the plurality of main grooves has a groove wall angle on a vehicle inner side set to be smaller than a groove wall angle on a vehicle outer side.

The plurality of rows of land portions include a center land portion located on a tire equator, a pair of intermediate land portions located on both outer sides of the center land portion, and a pair of shoulder land portions each located on an outer side of each of the intermediate land portions.

The pair of shoulder land portions each include a plurality of shoulder lug grooves extending in a tire width direction, and the shoulder lug grooves that are formed in at least one shoulder land portion of the pair of shoulder land portions communicate with a main groove adjacent to the shoulder land portion.

The intermediate land portions each include a plurality of intermediate lug grooves having one end portion opening to one of the main grooves and the other end portion terminating within the intermediate land portions, a plurality of first sipes having one end portion opening to the main groove to which the intermediate lug grooves open and the other end portion opening to the intermediate lug grooves, and a plurality of second sipes having one end portion opening to the main groove located opposite to the main groove to which the intermediate lug grooves open and the other end portion opening to the intermediate lug grooves.

The first sipe and the second sipe each include a chamfered portion on only one of an edge on a step-in side and an edge on a kick-out side.

The present technology allows, in at least one main groove, the groove wall angle on the vehicle inner side to be set relatively small, thus the volume of the main groove can be ensured, and wet performance and snow performance can be improved. On the other hand, in at least one main groove, the groove wall angle on the vehicle outer side is set relatively large, and thus the land portion adjacent to the main groove can be prevented from flexing in the tire width direction, and dry performance can be improved. The shoulder lug groove formed in at least one of the shoulder land portions communicates with the main groove adjacent to the shoulder land portion, and the intermediate lug grooves, the first sipes, the second sipes, and the chamfered portions are formed in each of the intermediate land portions. Accordingly, the drainage effect and the edge effect can be sufficiently ensured, and wet performance and snow performance can be improved. As a result, dry performance, wet performance, and snow performance can be improved to a high degree.

In the present technology, the tire, the mounting direction of which is specified to the vehicle means a tire including an indicator that indicates the mounting direction with respect to the vehicle. The main groove means a circumferential groove provided with a wear indicator, and the sipe means a groove having a groove width of 1.5 mm or less.

In the present technology, of the plurality of main grooves, the main groove located on a vehicle innermost side preferably has the groove wall angle on the vehicle inner side equal to the groove wall angle on the outer side, and the main grooves other than the main groove located on the vehicle innermost side preferably have the groove wall angle on the vehicle inner side smaller than the groove wall angle on the vehicle outer side. Since the main groove located on the vehicle innermost side is important in terms of drainage properties and snow discharge properties, the effect of improving wet performance and snow performance can be enhanced by setting the groove wall angles on both sides of the main groove to be equal. In this case, the groove wall angle on the vehicle inner side and the groove wall angle on the vehicle outer side of the main groove located on the vehicle innermost side are preferably set to be smaller than the groove wall angle on the vehicle outer side of the main groove other than the main groove located on the vehicle innermost side.

The shoulder lug groove formed in the shoulder land portion located on the vehicle inner side of the pair of shoulder land portions preferably opens to the main groove adjacent to the shoulder land portion, and the shoulder lug groove formed in the shoulder land portion located on the vehicle outer side preferably does not communicate with the main groove adjacent to the shoulder land portion. The shoulder lug grooves formed in the shoulder land portion located on the vehicle inner side open to the main groove, and thus drainage properties and snow discharge properties can be ensured, and the effect of improving wet performance and snow performance can be enhanced. On the other hand, the shoulder lug grooves formed in the shoulder land portion located on the vehicle outer side do not communicate with the main groove, and thus dry performance can be improved. Further, passing-by noise caused by the tire can be reduced.

The chamfered portion preferably has a curved surface recessed toward an inside of the intermediate land portion. As a result, the water discharge volume and the snow discharge volume can be increased, and the effect of improving wet performance and snow performance can be enhanced.

The intermediate land portion includes a plurality of third sipes extending on respective extension lines of the first sipe and the second sipe and having no chamfered portion. By disposing the plurality of third sipes having no chamfered portion, in addition to the first sipes and the second sipes each having the chamfered portion, in a mixed manner as just described, wet performance and snow performance can be improved, and an actual ground contact area of the tread portion can be sufficiently ensured and dry performance can be improved.

The intermediate land portion preferably includes a plurality of longitudinal sipes extending in the tire circumferential direction. By disposing the longitudinal sipes in the intermediate land portion, edges in the tire circumferential direction can be ensured and cornering performance particularly during running on snow can be improved.

The intermediate land portion preferably includes a plurality of third sipes extending on respective extension lines of the first sipe and the second sipe and having no chamfered portion and a plurality of longitudinal sipes extending in the tire circumferential direction. The intermediate lug groove preferably includes a first groove portion from an opening end to a bend point and a second groove portion from the bend point to a terminating end. The plurality of longitudinal sipes preferably branch from the third sipes and the intermediate lug grooves, the longitudinal sipes branching from the third sipes extend in the tire circumferential direction from a position corresponding to 20% to 80% of a length of the third sipes from an opening end of the third sipes to the main groove and terminate within the intermediate land portion, and the longitudinal sipes branching from the intermediate lug grooves extend in the tire circumferential direction from a position within 5 mm from a bent corner portion of the intermediate lug groove and terminate within the intermediate land portion. By defining the arrangement of the longitudinal sipes in the intermediate land portion as just described, edges in the tire circumferential direction can be ensured without impairing dry performance and cornering performance particularly during running on snow can be improved.

The center land portion preferably includes a circumferential narrow groove extending in the tire circumferential direction, a plurality of center lug grooves each having one end portion opening to the main groove adjacent to the center land portion and the other end portion terminating within the center land portion, and a plurality of center sipes having one end portion opening to the main groove adjacent to the center land portion and the other end portion terminating within the center land portion. Inclination angles with respect to the tire circumferential direction at opening ends of the center lug groove and the center sipe preferably range from 50° to 80°. Lengths in the tire width direction of the center lug groove and the center sipe are preferably 40% to 80% of a distance from the main groove to the circumferential narrow groove. A mutual interval between the center lug groove and the center sipe in the tire circumferential direction preferably ranges from 5 mm to 20 mm. The center land portion includes, in addition to the circumferential narrow groove, the center lug grooves and the center sipes that do not split the center land portion as just described, and thus wet performance can be improved without decreasing dry performance.

The shoulder land portion preferably includes a plurality of shoulder sipes extending in a zigzag manner in the tire width direction and a plurality of longitudinal sipes extending from the shoulder sipes in the tire circumferential direction. The shoulder land portion includes the longitudinal sipes in addition to the zigzag shoulder sipes as just described, and thus wet performance and snow performance can be improved.

The intermediate lug groove preferably has a bent shape and includes a first groove portion from an opening end to a bend point and a second groove portion from the bend point to a terminating end. The bend point is preferably at a position corresponding to 60% to 90% of a width of the intermediate land portion from an opening end of the intermediate lug groove. A length La of the first groove portion and a length Lb of the second groove portion preferably satisfy a relationship 0.3×La<Lb<0.8×La. An angle θ formed by the first groove portion and the second groove portion at the bend point is preferably in a range of 0°<θ<90°. The intermediate lug groove has a predetermined bent shape as just described, and thus the traction effect during travel increases, and dry performance and wet performance can be improved.

The tire according to an embodiment of the present technology is preferably a pneumatic tire but may be a non-pneumatic tire. In a case of a pneumatic tire, the interior thereof can be filled with any gas including air and inert gas such as nitrogen.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of the pneumatic tire of FIG. 1.

FIG. 3 is a contour diagram illustrating a contour of a meridian cross-section of a tread portion of the pneumatic tire in FIG. 1.

FIG. 4 is a plan view illustrating a main portion of the tread pattern of the pneumatic tire of FIG. 1.

FIG. 5 is a cross-sectional view from the arrow direction of the line V-V in FIG. 4.

### DETAILED DESCRIPTION

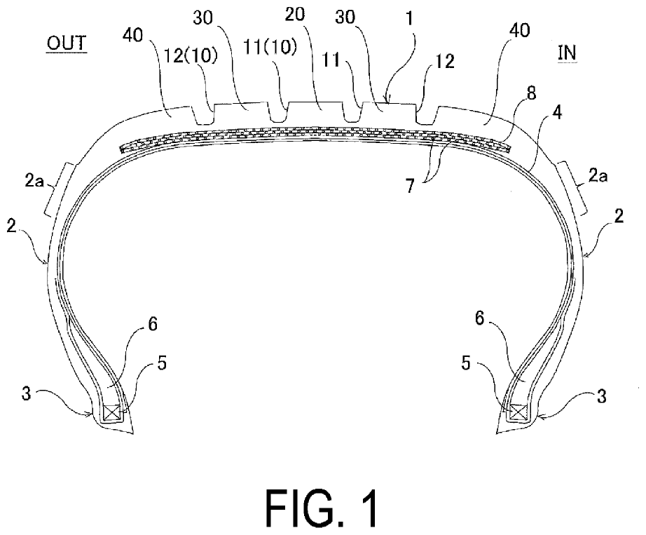

Configurations of embodiments of the present technology will be described in detail below with reference to the accompanying drawings. FIGS. 1 to 5 illustrate a pneumatic tire according to an embodiment of the present technology. This pneumatic tire has a mounting direction of tire front/back that is designated when mounted on a vehicle. In FIGS. 1 to 3, “IN” refers to a vehicle inner side when the tire is mounted on a vehicle and “OUT” refers to a vehicle outer side when the tire is mounted on the vehicle.

As illustrated in FIG. 1, a pneumatic tire of the present embodiment includes an annular tread portion 1 extending in the tire circumferential direction, a pair of sidewall portions 2, 2 disposed on both sides of the tread portion 1, and a pair of bead portions 3, 3 disposed on an inner side of the sidewall portions 2 in the tire radial direction. For example, a mounting direction indicator 2a indicating the mounting direction to the vehicle is formed on at least the sidewall portion 2 on the vehicle outer side. The mounting direction indicator 2a indicates, for example, “OUTSIDE” along the tire circumferential direction on the vehicle outer side and indicates, for example, “INSIDE” along the tire circumferential direction on the vehicle inner side.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5.

On the other hand, a plurality of belt layers 7 is embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

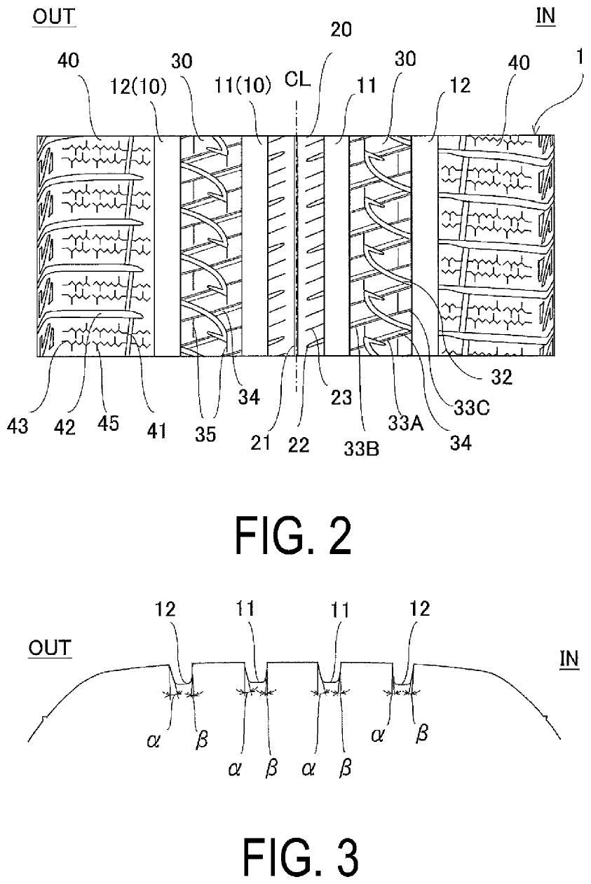

As illustrated in FIG. 2, a plurality of main grooves 10 extending in the tire circumferential direction is formed in the tread portion 1. Each of the main grooves 10 has a groove width in a range of 7 mm to 23 mm and a groove depth in a range of 3 mm to 12 mm. The main grooves 10 include a pair of center main grooves 11, 11 located on both side of a tire equator CL and a pair of shoulder main grooves 12, 12 located on the outer side of each of the center main grooves 11, 11.

As illustrated in FIG. 3, when a groove wall angle on the vehicle outer side of the main groove 10 is a and a groove wall angle on the vehicle inner side of the main groove 10 is B, at least one main groove 10 of the plurality of main grooves 10 is set such that the groove wall angle β on the vehicle inner side is smaller than the groove wall angle α on the vehicle outer side. The groove wall angles α and β are inclination angles of the side walls of the main groove 10 with respect to a straight line passing through the edge of the main groove 10 on the tread surface of the tread portion 1 and orthogonal to the tread surface of the tread portion 1 in the tire meridian cross-section. The groove wall angles α and β are selected from a range of, for example, 2° to 40°. When the groove wall angle β on the vehicle inner side is made smaller than the groove wall angle α on the vehicle outer side, the angle difference (α−β) is preferably 4° to 20°.

In the tread portion 1, a center land portion 20 located on the tire equator CL, a pair of intermediate land portions 30, 30 located on both outer sides of the center land portion 20, and a pair of shoulder land portions 40, 40 located on the outer side of each of the intermediate land portions 30 are defined.

In the center land portion 20, a circumferential narrow groove 21 extending in the tire circumferential direction, a plurality of center lug grooves 22 each having one end portion opening to the center main groove 11 adjacent to the center land portion 20 and the other end portion terminating within the center land portion 20, and a plurality of center sipes 23 each having one end portion opening to the center main groove 11 adjacent to the center land portion 20 and the other end portion terminating within the center land portion 20 are formed. The circumferential narrow groove 21 has, for example, a groove width in a range of 6% to 16% of the groove width of the main groove 10 and a groove depth in a range of 25% to 60% of a groove depth of the main groove 10. The center lug grooves 22 and the center sipes 23 are regularly or irregularly mixed along the tire circumferential direction and are disposed at intervals along the tire circumferential direction.

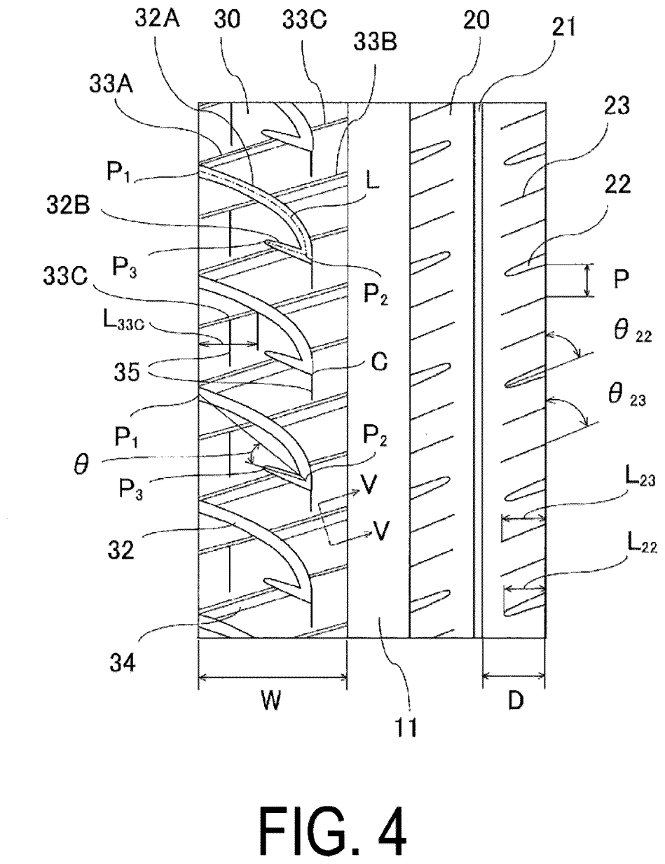

In each of the intermediate land portions 30, a plurality of intermediate lug grooves 32 each having one end position opening to the shoulder main groove 12 and the other end portion terminating within the intermediate land portion 30, a plurality of first sipes 33A each having one end portion opening to the shoulder main groove 12 to which the intermediate lug groove 32 opens and the other end portion opening to the intermediate lug groove 32, and a plurality of second sipes 33B each having one end portion opening to the center main groove 11 located on the opposite side of the shoulder main groove 12 to which the intermediate lug groove 32 opens and the other end portion opening to the intermediate lug groove 32 are formed. The intermediate lug groove 32 has a bent shape and includes a first groove portion 32A from an opening end P₁ to a bend point P₂ and a second groove portion 32B from the bend point P₂ to a terminating end P₃ (see FIG. 4). The intermediate lug groove 32 may have one end portion opening to the center main groove 11. Each of the first sipe 33A and the second sipe 33B has a chamfered portion 34 on only one of the edge on the step-in side (one side in the tire circumferential direction) and the edge on the kick-out side (the other side in the tire circumferential direction).

In each of the intermediate land portions 30, a plurality of third sipes 33C extending on respective extension lines of the first sipe 33A and the second sipe 33B and having no chamfered portion, and a plurality of longitudinal sipes 35 extending in the tire circumferential direction are formed.

Each of the third sipes 33C having one end portion opening to the shoulder main groove 12 to which the intermediate lug groove 32 opens and the other end portion opening to the intermediate lug groove 32. Each of the longitudinal sipes 35 branches from the third sipe 33C or the intermediate lug groove 32.

In each of the shoulder land portions 40, a plurality of shoulder lug grooves 42 extending in the tire width direction are formed. The shoulder lug grooves 42 formed in at least one of the shoulder land portions 40 communicate with the shoulder main groove 12 adjacent to the shoulder land portion 40. In FIG. 2, the shoulder lug grooves 42 formed in the shoulder land portion 40 located on the vehicle inner side open to the shoulder main groove 12, and in the meanwhile, the shoulder lug grooves 42 formed in the shoulder land portion 40 located on the vehicle outer side do not communicate with the shoulder main groove 12.

In each of the shoulder land portions 40, a plurality of longitudinal grooves 41 connecting a pair of shoulder lug grooves 42, 42 adjacent to each other in the tire circumferential direction, a plurality of shoulder sipes 43 extending in a zigzag manner in the tire width direction, and a plurality of longitudinal sipes 45 extending from the shoulder sipes 43 in the tire circumferential direction are formed.

According to the pneumatic tire described above, in at least one main groove 10, the groove wall angle β on the vehicle inner side is set relatively small, and thus the volume of the main groove 10 can be ensured, and wet performance and snow performance can be improved. On the other hand, in at least one main groove 10, the groove wall angle α on the vehicle outer side is set relatively large, and thus the land portion 20, 30, or 40 adjacent to the main groove 10 can be prevented from flexing in the tire width direction, and dry performance can be improved. The shoulder lug grooves 42 formed in at least one shoulder land portion 40 communicate with the shoulder main groove 12, and the intermediate lug grooves 32, the first sipes 33A, the second sipes 33B, and the chamfered portions 34 are formed in each of the intermediate land portions 30. Accordingly, the drainage effect and the edge effect can be sufficiently ensured, and wet performance and snow performance can be improved. In particular, the first sipe 33A and the second sipe 33B that are each provided with the chamfered portion 34 effectively take in water on the road surface and guide the water into the intermediate lug groove 32 while suppressing a decrease in rigidity of the intermediate land portion 30. The intermediate lug groove 32 has one end portion opened to any of the main grooves 10 and the other end portion terminated within the intermediate land portion 30, and thus a decrease in rigidity of the intermediate land portion 30 can be suppressed. As a result, dry performance, wet performance, and snow performance can be improved to a high degree.

As illustrated in FIG. 3, in the pneumatic tire described above, the main groove 10 located on the vehicle innermost side of the plurality of main grooves 10 (i.e., the shoulder main groove 12 on the vehicle inner side) preferably has the groove wall angle β on the vehicle inner side and the groove wall angle α on the vehicle outer side equal to each other, and the main grooves 10 (i.e., the pair of center main grooves 11 and the shoulder main groove 12 on the vehicle outer side) other than the main groove located on the vehicle innermost side preferably have the groove wall angle β on the vehicle inner side and the groove wall angle α on the vehicle outer side smaller than the groove wall angle β on the vehicle inner side. Since the main groove 10 located on the vehicle innermost side is important in terms of drainage properties and snow discharge properties, the effect of improving wet performance and snow performance can be enhanced by setting the groove wall angles α and β on both sides of the main groove 10 to be equal. In this case, in principle, the groove wall angle β on the vehicle inner side and the groove wall angle α on the vehicle outer side of the main groove 10 located on the vehicle innermost side are set to be smaller than the groove wall angle α on the vehicle outer side of the other main grooves 10.

As illustrated in FIG. 2, in the pneumatic tire described above, the shoulder lug grooves 42 formed in the shoulder land portion 40 located on the vehicle inner side preferably open to the shoulder main groove 12, and the shoulder lug grooves 42 formed in the shoulder land portion 40 located on the vehicle outer side preferably do not communicate with the shoulder main groove 12. The shoulder lug grooves 42 formed in the shoulder land portion 40 are located on the vehicle inner side open to the shoulder main groove 12, and thus drainage properties and snow discharge properties can be ensured, and the effect of improving wet performance and snow performance can be enhanced. On the other hand, the shoulder lug grooves 42 formed in the shoulder land portion 40 located on the vehicle outer side do not communicate with the shoulder main groove 12, and thus dry performance can be improved, Further, passing-by noise caused by the tire can be reduced.

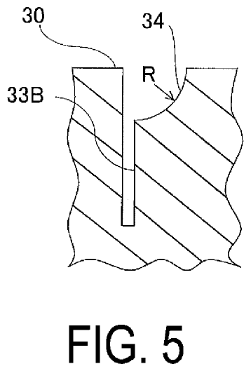

As illustrated in FIG. 5, in the pneumatic tire described above, the chamfered portion 34 preferably has a curved surface recessed toward an inside of the intermediate land portion 30. As a result, the water discharge volume and the snow discharge volume based on the chamfered portion 34 can be increased, and the effect of improving wet performance and snow performance can be enhanced. The curved surface of the chamfered portion 34 preferably has a curvature radius R of 1.0 mm to 3.0 mm.

As illustrated in FIG. 4, in the pneumatic tire described above, the intermediate land portion 30 preferably includes the plurality of third sipes 33C extending on respective extension lines of the first sipe 33A and the second sipe 33B and having no chamfered portion. By disposing the plurality of third sipes 33C having no chamfered portion, in addition to the first sipes 33A and the second sipes 33B each having the chamfered portion 34, in a mixed manner as just described, wet performance and snow performance can be improved, and an actual ground contact area of the tread portion 1 can be sufficiently ensured and dry performance can be improved. More specifically, as illustrated in FIG. 2, it is preferable that the first sipe 33A and the second sipe 33B are alternately disposed along the tire circumferential direction and that the third sipe 33C is disposed on an extension line of each of the first sipe 33A and the second sipe 33B.

As illustrated in FIG. 4, in the pneumatic tire described above, the intermediate land portion 30 preferably includes the plurality of longitudinal sipes 35 extending in the tire circumferential direction. By disposing the longitudinal sipes 35 in the intermediate land portion 30, edges in the tire circumferential direction can be ensured and cornering performance particularly during running on snow can be improved.

As illustrated in FIG. 4, in the pneumatic tire described above, the plurality of longitudinal sipes 35 branch from the third sipes 33C and the intermediate lug grooves 32. The longitudinal sipe 35 branching from the third sipe 33C preferably extends in the tire circumferential direction from a position corresponding to 20% to 80% of a length L_{33C} of the third sipe 33C from an opening end of the third sipe 33C to the shoulder main groove 12 and terminates within the intermediate land portion 30. The longitudinal sipe 35 branching from the intermediate lug groove 32 preferably extends in the tire circumferential direction from a position within 5 mm from a bent corner portion C of the intermediate lug groove 32 and terminates within the intermediate land portion 30. By defining the arrangement of the longitudinal sipes 35 in the intermediate land portion 30 as just described, edges in the tire circumferential direction can be ensured without impairing dry performance and cornering performance particularly during running on snow can be improved. Here, when the starting point of the longitudinal sipe 35 deviates from the aforementioned range, the rigidity of the intermediate land portion 30 decreases, which causes a decrease in dry performance.

As illustrated in FIG. 4, in the pneumatic tire described above, preferably, the center land portion 20 includes the circumferential narrow groove 21 extending in the tire circumferential direction, the plurality of center lug grooves 22 each having one end portion opening to the center main groove 11 adjacent to the center land portion 20 and the other end portion terminating within the center land portion 20, and the plurality of center sipes 23 each having one end portion opening to the center main groove 11 adjacent to the center land portion 20 and the other end portion terminating within the center land portion 20, inclination angles θ22 and 023 with respect to the tire circumferential direction at opening ends of the center lug groove 22 and the center sipe 23 each range from 50° to 80°, lengths L₂₂ and L₂₃ in the tire width direction of the center lug groove 22 and the center sipe 23 are each 40% to 80% of a distance D from the center main groove 11 to the circumferential narrow groove 21, and a mutual interval P between the center lug groove 22 and the center sipe 23 in the tire circumferential direction ranges from 5 mm to 20 mm. The center land portion 20 includes, in addition to the circumferential narrow groove 21, the center lug grooves 22 and the center sipes 23 that do not split the center land portion 20 as just described, and thus wet performance can be improved without decreasing dry performance.

Here, when the inclination angles θ₂₂ and θ₂₃ of the center lug groove 22 and the center sipe 23 are smaller than 50°, the rigidity of the center land portion 20 decreases and the effect of improving dry performance decreases. In contrast, when the inclination angles are larger than 80°, the effect of improving wet performance and snow performance decreases. When the lengths L₂₂ and L₂₃ of the center lug groove 22 and the center sipe 23 are less than 40% of the distance D, the effect of improving wet performance and snow performance decreases. In contrast, when the L₂₂ and L₂₃ are more than 80% of the distance D, the rigidity of the center land portion 20 decreases and the effect of improving dry performance decreases. Furthermore, when the mutual interval P between the center lug groove 22 and the center sipe 23 in the tire circumferential direction is less than 5 mm, the rigidity of the center land portion 20 decreases and the effect of improving dry performance decreases. In contrast, when the mutual interval P exceeds 20 mm, the effect of improving wet performance and snow performance decreases.

As illustrated in FIG. 4, in the pneumatic tire described above, the shoulder land portion 40 preferably includes the plurality of shoulder sipes 43 extending in a zigzag manner in the tire width direction and the plurality of longitudinal sipes 45 extending from the shoulder sipes 43 in the tire circumferential direction. The shoulder land portion 40 includes the longitudinal sipes 45 in addition to the zigzag shoulder sipes 43 as just described, and thus wet performance and snow performance can be improved.

As illustrated in FIG. 4, in the pneumatic tire described above, the intermediate lug groove 32 has a bent shape and includes the first groove portion 32A from the opening end P₁ to the bend point P₂ and the second groove portion 32B from the bend point P₂ to the terminating end P₃; however, the bend point P₂ is preferably at a position corresponding to 60% to 90% of a width W of the intermediate land portion 30 from the opening end P₁ of the intermediate lug groove 32. A length La of the first groove portion 32A and a length Lb of the second groove portion 32B preferably satisfy the relationship 0.3×La<Lb<0.8×La. The length La of the first groove portion 32A is a length from the opening end P₁ to the bend point P₂ measured along a center line L of the intermediate lug groove 32, and the length Lb of the second groove portion 32B is a length from the bend point P₂ to the terminating end P₃ measured along the center line L of the intermediate lug groove 32. Furthermore, an angle θ formed by the first groove portion 32A and the second groove portion 32B at the bend point P₂ is preferably in the range 0°<θ<90°. The angle θ is an angle formed by a straight line connecting the bend point P₂ and the terminating end P₃ of the intermediate lug groove 32 with respect to a straight line connecting the opening end P₁ and the bend point P₂. The intermediate lug groove 32 has a predetermined bent shape as just described, and thus the traction effect during travel increases, and dry performance and wet performance can be improved.

Here, when the distance in the tire width direction from the opening end P₁ to the bend point P₂ of the intermediate lug groove 32 is less than 60% of the width W of the intermediate land portion 30, the effect of improving wet performance and snow performance decreases. In contrast, when the distance is more than 90%, the rigidity of the intermediate land portion 30 decreases and the effect of improving dry performance decreases. When the ratio Lb/La is 0.3 or less, the effect of improving wet performance and snow performance decreases. In contrast, when the ratio Lb/La is 0.8 or more, the rigidity of the intermediate land portion 30 decreases and the effect of improving dry performance decreases. Furthermore, when the angle θ formed by the first groove portion 32A and the second groove portion 32B is 90° or more, the effect of increasing traction effect decreases.

Although the case of a pneumatic tire has been described in the aforementioned embodiment, the present technology is also applicable to a non-pneumatic tire. The non-pneumatic tire is provided with an annular tread portion along the tire circumferential direction in the same way as the pneumatic tire; however, a similar tread pattern may be provided to the tread portion.

### EXAMPLES

Tires of Conventional Example, Comparative Examples 1 to 3, and Examples 1 to 8 were manufactured. The tires each include, in a tread portion, four main grooves extending in a tire circumferential direction and a five land portions defined by the four main grooves. In a pneumatic tire, a mounting direction of which is specified to a vehicle (front wheel size: 285/40R22, rear wheel size: 315/35R22), a groove wall angle α on the vehicle outer side and a groove wall angle β on the vehicle inner side of each of the main grooves, the presence of communication of a shoulder lug groove with the main groove, the presence of intermediate lug grooves in an intermediate land portion, the presence of first sipes (with chamfered portions) in the intermediate land portion, the presence of second sipes (with chamfered portions) in the intermediate land portion, the presence of longitudinal sipes in the intermediate land portion, the presence of curved surfaces on the chamfered portions, the presence of a circumferential narrow groove in a center land portion, the presence of center lug grooves in the center land portion, the presence of center sipes in the center land portion, the presence of third sipes in the intermediate land portion, the presence of shoulder sipes in a shoulder land portion, and the presence of longitudinal sipes in the shoulder land portion were set as indicated in Tables 1 and 2. Note that the intermediate lug groove has a bent shape.

These test tires were evaluated for steering stability on dry road surfaces, steering stability on wet road surfaces, and steering stability on snowy road surfaces by the following test methods, and the results are also given in Tables 1 and 2.

### Steering Stability on Dry Road Surfaces:

Each test tire was mounted on a wheel (front wheel rim size: 22×10J, rear wheel rim size: 22×11.5J) and was mounted on a test vehicle, air pressure (F/R) after warm-up was set to 250 kPa/260 kPa, and sensory evaluation during travel on dry road surfaces was conducted by a test driver. Evaluation results are expressed as index values with the value of Conventional Example being defined as 100. Larger index values indicate superior steering stability on dry road surfaces.

### Steering Stability on Wet Road Surfaces:

Each test tire was mounted on a wheel (front wheel rim size: 22×10J, rear wheel rim size: 22×11.5J) and was mounted on a test vehicle, air pressure (F/R) after warm-up was set to 250 kPa/260 kPa, and sensory evaluation during travel on wet road surfaces was conducted by a test driver. Evaluation results are expressed as index values with the value of Conventional Example being defined as 100. Larger index values indicate superior steering stability on wet road surfaces.

### Steering Stability on Snowy Road Surfaces:

Each test tire was mounted on a wheel (front wheel rim size: 22×10J, rear wheel rim size: 22×11.5J) and was mounted on a test vehicle, air pressure (F/R) after warm-up was set to 250 kPa/260 kPa, and sensory evaluation during travel on snowy road surfaces was conducted by a test driver. Evaluation results are expressed as index values with the value of Conventional Example being defined as 100. Larger index values indicate superior steering stability on snowy road surfaces.

TABLE 1

| | | | | Comparative | Comparative |
|---|---|---|---|---|---|
| | | | Conventional | Example | Example |
| | | | Example | 1 | 2 |
| Groove | Shoulder main groove | α (°) | 15 | 7 | 15 |
| wall | on vehicle outer side | β (°) | 15 | 15 | 7 |
| angle | Center main groove | α (°) | 15 | 7 | 15 |
| | on vehicle outer side | β (°) | 15 | 15 | 7 |
| | Center main groove | α (°) | 15 | 7 | 15 |
| | on vehicle inner side | β (°) | 15 | 15 | 7 |
| | Shoulder main groove | α (°) | 15 | 7 | 15 |
| | on vehicle inner side | β (°) | 15 | 15 | 7 |
| Presence of communication of | | Vehicle | No | No | No |
| shoulder lug groove | | outer side | | | |
| | | Vehicle | No | No | No |
| | | inner side | | | |
| Presence of intermediate lug grooves in | | | Yes | Yes | Yes |
| intermediate land portion | | | | | |
| Presence of first sipes in intermediate land | | | No | No | No |
| portion | | | | | |
| Presence of second sipes in intermediate | | | No | No | No |
| land portion | | | | | |
| Presence of longitudinal sipes in | | | No | No | No |
| intermediate land portion | | | | | |
| Presence of curved surface on chamfered | | | No | No | No |
| portion | | | | | |
| Presence of circumferential narrow groove | | | No | No | No |
| in center land portion | | | | | |
| Presence of center lug grooves in center | | | Yes | Yes | Yes |
| land portion | | | | | |
| Presence of center sipes in center land | | | Yes | Yes | Yes |
| portion | | | | | |
| Presence of third sipes in intermediate | | | No | No | No |
| land portion | | | | | |
| Presence of shoulder sipes in shoulder | | | No | No | No |
| land portion | | | | | |
| Presence of longitudinal sipes in shoulder | | | No | No | No |
| land portion | | | | | |
| Steering stability on dry road surfaces | | | 100 | 99 | 101 |
| (index value) | | | | | |
| Steering stability on wet road surfaces | | | 100 | 101 | 102 |
| (index value) | | | | | |
| Steering stability on snowy road surfaces | | | 100 | 101 | 102 |
| (index value) | | | | | |
| | | | Comparative | | |
| | | | Example | Example | Example |
| | | | 3 | 1 | 2 |
| Groove | Shoulder main groove | α (°) | 15 | 15 | 15 |
| wall | on vehicle outer side | β (°) | 7 | 7 | 7 |
| angle | Center main groove on | α (°) | 15 | 15 | 15 |
| | vehicle outer side | β (°) | 7 | 7 | 7 |
| | Center main groove on | α (°) | 15 | 15 | 15 |
| | vehicle inner side | β (°) | 7 | 7 | 7 |
| | Shoulder main groove | α (°) | 15 | 15 | 15 |
| | on vehicle inner side | β (°) | 7 | 7 | 7 |
| Presence of communication of | | Vehicle | Yes | Yes | Yes |
| shoulder lug groove | | outer side | | | |
| | | Vehicle | No | No | No |
| | | inner side | | | |

| | | | |
|---|---|---|---|
| Presence of intermediate lug grooves in | Yes | Yes | Yes |
| intermediate land portion | | | |
| Presence of first sipes in intermediate land | No | Yes | Yes |
| portion | | | |
| Presence of second sipes in intermediate | No | Yes | Yes |
| land portion | | | |
| Presence of longitudinal sipes in | No | No | Yes |
| intermediate land portion | | | |
| Presence of curved surface on chamfered | No | No | No |
| portion | | | |
| Presence of circumferential narrow groove | No | No | No |
| in center land portion | | | |
| Presence of center lug grooves in center | Yes | Yes | Yes |
| land portion | | | |
| Presence of center sipes in center land | Yes | Yes | Yes |
| portion | | | |
| Presence of third sipes in intermediate | No | No | No |
| land portion | | | |
| Presence of shoulder sipes in shoulder | No | No | No |
| land portion | | | |
| Presence of longitudinal sipes in shoulder | No | No | No |
| land portion | | | |
| Steering stability on dry road surfaces | 101 | 101 | 101 |
| (index value) | | | |
| Steering stability on wet road surfaces | 103 | 105 | 106 |
| (index value) | | | |
| Steering stability on snowy road surfaces | 103 | 105 | 106 |
| (index value) | | | |

TABLE 2

| | | | Example | Example | Example |
|---|---|---|---|---|---|
| | | | 3 | 4 | 5 |
| Groove | Shoulder main groove | α (°) | 15 | 15 | 15 |
| wall angle | on vehicle outer side | β (°) | 7 | 7 | 7 |
| | Center main groove | α (°) | 15 | 15 | 15 |
| | on vehicle outer side | β (°) | 7 | 7 | 7 |
| | Center main groove | α (°) | 15 | 15 | 15 |
| | on vehicle inner side | β (°) | 7 | 7 | 7 |
| | Shoulder main groove | α (°) | 7 | 7 | 7 |
| | on vehicle inner side | β (°) | 7 | 7 | 7 |
| Presence of communication of | | Vehicle | Yes | No | No |
| shoulder lug groove | | outer side | | | |
| | | Vehicle | No | Yes | Yes |
| | | inner side | | | |
| Presence of intermediate lug grooves in intermediate | | | Yes | Yes | Yes |
| land portion | | | | | |
| Presence of first sipes in intermediate land portion | | | Yes | Yes | Yes |
| Presence of second sipes in intermediate land portion | | | Yes | Yes | Yes |
| Presence of longitudinal sipes in intermediate land | | | Yes | Yes | Yes |
| portion | | | | | |
| Presence of curved surface on chamfered portion | | | No | No | Yes |
| Presence of circumferential narrow groove in center | | | No | No | No |
| land portion | | | | | |
| Presence of center lug grooves in center land portion | | | Yes | Yes | Yes |
| Presence of center sipes in center land portion | | | Yes | Yes | Yes |
| Presence of third sipes in intermediate land portion | | | No | No | No |
| Presence of shoulder sipes in shoulder land portion | | | No | No | No |
| Presence of longitudinal sipes in shoulder land | | | No | No | No |
| portion | | | | | |
| Steering stability on dry road surfaces (index value) | | | 101 | 101 | 101 |
| Steering stability on wet road surfaces (index value) | | | 107 | 108 | 109 |
| Steering stability on snowy road surfaces (index | | | 107 | 108 | 109 |
| value) | | | | | |
| | | | Example | Example | Example |
| | | | 6 | 7 | 8 |
| Groove | Shoulder main groove | α (°) | 15 | 15 | 15 |
| wall angle | on vehicle outer side | β (°) | 7 | 7 | 7 |
| | Center main groove | α (°) | 15 | 15 | 15 |
| | on vehicle outer side | β (°) | 7 | 7 | 7 |
| | Center main groove | α (°) | 15 | 15 | 15 |
| | on vehicle inner side | β (°) | 7 | 7 | 7 |
| | Shoulder main groove | α (°) | 7 | 7 | 7 |
| | on vehicle inner side | β (°) | 7 | 7 | 7 |
| Presence of communication of | | Vehicle | No | No | No |
| shoulder lug groove | | outer side | | | |
| | | Vehicle | Yes | Yes | Yes |
| | | inner side | | | |

| | | | |
|---|---|---|---|
| Presence of intermediate lug grooves in intermediate | Yes | Yes | Yes |
| land portion | | | |
| Presence of first sipes in intermediate land portion | Yes | Yes | Yes |
| Presence of second sipes in intermediate land portion | Yes | Yes | Yes |
| Presence of longitudinal sipes in intermediate land | Yes | Yes | Yes |
| portion | | | |
| Presence of curved surface on chamfered portion | Yes | Yes | Yes |
| Presence of circumferential narrow groove in center | Yes | Yes | Yes |
| land portion | | | |
| Presence of center lug grooves in center land portion | Yes | Yes | Yes |
| Presence of center sipes in center land portion | Yes | Yes | Yes |
| Presence of third sipes in intermediate land portion | No | Yes | Yes |
| Presence of shoulder sipes in shoulder land portion | No | No | Yes |
| Presence of longitudinal sipes in shoulder land | No | No | Yes |
| portion | | | |
| Steering stability on dry road surfaces (index value) | 101 | 101 | 101 |
| Steering stability on wet road surfaces (index value) | 110 | 111 | 112 |
| Steering stability on snowy road surfaces (index | 110 | 111 | 112 |

value)

As can be seen from Tables 1 and 2, in the tires of Examples 1 to 8, steering stability on dry road surfaces, steering stability on wet road surfaces, and steering stability on snowy road surfaces were improved to a high degree in comparison with Conventional Example. In contrast, since Comparative Examples 1 to 3 did not satisfy the requirements, the effect of improving the steering stabilities was not sufficient.

1. A tire comprising, in a tread portion, a plurality of main grooves extending in a tire circumferential direction and a plurality of rows of land portions defined by the plurality of main grooves and having a specified mounting direction to a vehicle,
at least one main groove of the plurality of main grooves having a groove wall angle on a vehicle inner side set to be smaller than a groove wall angle on a vehicle outer side,
the plurality of rows of land portions comprising a center land portion located on a tire equator, a pair of intermediate land portions located on both outer sides of the center land portion, and a pair of shoulder land portions each located on an outer side of each of the intermediate land portions,
the pair of shoulder land portions each comprising a plurality of shoulder lug grooves extending in a tire width direction, and shoulder lug grooves that are formed in at least one shoulder land portion of the pair of shoulder land portions communicating with a main groove adjacent to the shoulder land portion,
the intermediate land portions each comprising a plurality of intermediate lug grooves having one end portion opening to one of the main grooves and the other end portion terminating within the intermediate land portions, a plurality of first sipes having one end portion opening to the main groove to which the intermediate lug grooves open and the other end portion opening to the intermediate lug grooves, and a plurality of second sipes having one end portion opening to the main groove located opposite to the main groove to which the intermediate lug grooves open and the other end portion opening to the intermediate lug grooves, and
the first sipe and the second sipe each comprising a chamfered portion on only one of an edge on a step-in side and an edge on a kick-out side.

2. The tire according to claim 1, wherein
of the plurality of main grooves, a main groove located on a vehicle innermost side has the groove wall angle on the vehicle inner side and the groove wall angle on the outer side equal to each other, and
main grooves other than the main groove located on the vehicle innermost side have the groove wall angle on the vehicle inner side and the groove wall angle on the vehicle outer side smaller than the groove wall angle on the vehicle inner side.

3. The tire according to claim 1, wherein
shoulder lug grooves formed in a shoulder land portion located on the vehicle inner side of the pair of shoulder land portions open to a main groove adjacent to the shoulder land portion, and
shoulder lug grooves formed in a shoulder land portion located on the vehicle outer side of the pair of shoulder land portions do not communicate with a main groove adjacent to the shoulder land portion.

4. The tire according to claim 1, wherein the chamfered portion has a curved surface recessed toward an inside of the intermediate land portions.

5. The tire according to claim 1, wherein the intermediate land portions comprise a plurality of third sipes extending on respective extension lines of the first sipe and the second sipe and having no chamfered portion.

6. The tire according to claim 1, wherein the intermediate land portions comprise a plurality of longitudinal sipes extending in the tire circumferential direction.

7. The tire according to claim 1, wherein
the intermediate land portions comprise a plurality of third sipes extending on respective extension lines of the first sipe and the second sipe and having no chamfered portion and a plurality of longitudinal sipes extending in the tire circumferential direction,
the intermediate lug grooves have a bent shape and comprise a first groove portion from an opening end to a bend point and a second groove portion from the bend point to a terminating end, and
the plurality of longitudinal sipes branch from the third sipes and the intermediate lug grooves, the longitudinal sipes branching from the third sipes extend in the tire circumferential direction from a position corresponding to 20% to 80% of a length of the third sipes from an opening end of the third sipes to the main groove and terminate within the intermediate land portions, and the longitudinal sipes branching from the intermediate lug grooves extend in the tire circumferential direction from a position within 5 mm from a bent corner portion of the intermediate lug grooves and terminate within the intermediate land portions.

8. The tire according to claim 1, wherein
the center land portion comprises a circumferential narrow groove extending in the tire circumferential direction, a plurality of center lug grooves having one end portion opening to a main groove adjacent to the center land portion and the other end portion terminating within the center land portion, and a plurality of center sipes having one end portion opening to the main groove adjacent to the center land portion and the other end portion terminating within the center land portion,
inclination angles with respect to the tire circumferential direction at opening ends of the center lug groove and the center sipe range from 50° to 80°,
lengths in the tire width direction of the center lug groove and the center sipe are 40% to 80% of a distance from the main groove to the circumferential narrow groove, and
a mutual interval between the center lug groove and the center sipe in the tire circumferential direction ranges from 5 mm to 20 mm.

9. The tire according to claim 1, wherein the shoulder land portions comprise a plurality of shoulder sipes extending in a zigzag manner in the tire width direction and a plurality of longitudinal sipes extending from the shoulder sipes in the tire circumferential direction.

10. The tire according to claim 1, wherein
the intermediate lug grooves have a bent shape and comprise a first groove portion from an opening end to a bend point and a second groove portion from the bend point to a terminating end,
the bend point is at a position corresponding to 60% to 90% of a width of the intermediate land portion from an opening end of the intermediate lug grooves,
a length La of the first groove portion and a length Lb of the second groove portion satisfy a relationship 0.3×La<Lb<0.8×La, and
an angle θ formed by the first groove portion and the second groove portion at the bend point is in a range of 0°<θ<90°.

11. The tire according to claim 2, wherein
shoulder lug grooves formed in a shoulder land portion located on the vehicle inner side of the pair of shoulder land portions open to a main groove adjacent to the shoulder land portion, and
shoulder lug grooves formed in a shoulder land portion located on the vehicle outer side of the pair of shoulder land portions do not communicate with a main groove adjacent to the shoulder land portion.

12. The tire according to claim 11, wherein the chamfered portion has a curved surface recessed toward an inside of the intermediate land portions.

13. The tire according to claim 12, wherein the intermediate land portions comprise a plurality of third sipes extending on respective extension lines of the first sipe and the second sipe and having no chamfered portion.

14. The tire according to claim 13, wherein the intermediate land portions comprise a plurality of longitudinal sipes extending in the tire circumferential direction.

15. The tire according to claim 12, wherein
the intermediate land portions comprise a plurality of third sipes extending on respective extension lines of the first sipe and the second sipe and having no chamfered portion and a plurality of longitudinal sipes extending in the tire circumferential direction,
the intermediate lug grooves have a bent shape and comprise a first groove portion from an opening end to a bend point and a second groove portion from the bend point to a terminating end, and
the plurality of longitudinal sipes branch from the third sipes and the intermediate lug grooves, the longitudinal sipes branching from the third sipes extend in the tire circumferential direction from a position corresponding to 20% to 80% of a length of the third sipes from an opening end of the third sipes to the main groove and terminate within the intermediate land portions, and the longitudinal sipes branching from the intermediate lug grooves extend in the tire circumferential direction from a position within 5 mm from a bent corner portion of the intermediate lug grooves and terminate within the intermediate land portions.

16. The tire according to claim 15, wherein
the center land portion comprises a circumferential narrow groove extending in the tire circumferential direction, a plurality of center lug grooves having one end portion opening to a main groove adjacent to the center land portion and the other end portion terminating within the center land portion, and a plurality of center sipes having one end portion opening to the main groove adjacent to the center land portion and the other end portion terminating within the center land portion,
inclination angles with respect to the tire circumferential direction at opening ends of the center lug groove and the center sipe range from 50° to 80°,
lengths in the tire width direction of the center lug groove and the center sipe are 40% to 80% of a distance from the main groove to the circumferential narrow groove, and
a mutual interval between the center lug groove and the center sipe in the tire circumferential direction ranges from 5 mm to 20 mm.

17. The tire according to claim 16, wherein the shoulder land portions comprise a plurality of shoulder sipes extending in a zigzag manner in the tire width direction and a plurality of longitudinal sipes extending from the shoulder sipes in the tire circumferential direction.

18. The tire according to claim 17, wherein
the intermediate lug grooves have a bent shape and comprise a first groove portion from an opening end to a bend point and a second groove portion from the bend point to a terminating end,
the bend point is at a position corresponding to 60% to 90% of a width of the intermediate land portion from an opening end of the intermediate lug grooves,
a length La of the first groove portion and a length Lb of the second groove portion satisfy a relationship 0.3×La<Lb<0.8×La, and
an angle θ formed by the first groove portion and the second groove portion at the bend point is in a range of 0°<θ<90°.
